(19) United States
(12) Patent Application Publication
(10) Pub. No.: US 2010/0091180 A1
(43) Pub. Date: Apr. 15, 2010

(54) SIGNAL CONVERSION APPARATUSES AND DISPLAY SYSTEM

(75) Inventors: Shu-Ming LIU, Tainan County (TW); Lin-Kai Bu, Tainan County (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: HIMAX TECHNOLOGIES LIMITED, Tainan County (TW)

(21) Appl. No.: 12/249,983

(22) Filed: Oct. 13, 2008

(51) Int. Cl. H04N 7/01; H04N 5/66

(52) U.S. Cl. 348/441; 348/739; 348/E05.133; 348/E07.002

(57) ABSTRACT

A signal conversion apparatus is provided. A video input interface receives a video signal encoded in a first format from a host device. An audio input interface receives an audio signal encoded in a second format from the host device. A conversion unit is coupled to the video input interface and the audio input interface, receives the video signal and the audio signal therefrom, and converts the video signal and the audio signal into an output signal encoded in a predetermined format. An output interface receives the output signal and transmits the output signal to the display device.

### BACKGROUND OF THE INVENTION

1. Field of the Invention

The invention relates to a signal conversion apparatus, and more particularly to a signal conversion apparatus for converting analog/digital format video and audio signals into a DisplayPort format signal.

2. Description of the Related Art

DisplayPort is a digital display interface standard put forth by the Video Electronics Standards Association (VESA). It defines a new license-free, royalty-free, digital audio/video interconnect, intended to be used primarily between a computer and a display monitor, or a computer and a home-theater system.

The DisplayPort connector supports 1, 2, or 4 data pairs in a Main Link that also carries audio and clock signals, each with a symbol rate of 1.62 or 2.7 Gbit/s. The video signal path supports 6 to 16 bits per color channel. A bi-directional auxiliary channel (at a constant 1 Mbit/s) carries management and device control data for the Main Link using Video Electronics Standards Association (VESA) Extended display identification data (EDID) and VESA Monitor Control Command Set (MCCS) standards. The DisplayPort embeds the separate clock signals in the data signals. The data transmission protocol in the DisplayPort is based on micro packets and can be extended with future feature additions.

In addition to the micro packets protocol and embedded clock, the DisplayPort also supports internal chip-to-chip communications, which can drive display panels directly, thus eliminating control circuits and allowing for cheaper and slimmer displays. Therefore, a novel implementation of a signal conversion apparatus converting analog/digital format video and audio signals into a DisplayPort format signal for a display device is highly desired.

### BRIEF SUMMARY OF THE INVENTION

Signal conversion apparatuses and display system are provided. An exemplary embodiment of a signal conversion apparatus comprises a video input interface, an audio input interface, a conversion unit, and an output interface. The video input interface receives a video signal encoded in a first format from a host device. The audio input interface receives an audio signal encoded in a second format from the host device. The conversion unit is coupled to the video input interface and the audio input interface, receives the video signal and the audio signal therefrom, and converts the video signal and the audio signal into a output signal encoded in a predetermined format supported by a display device. The output interface receives the output signal and transmits the output signal to the display device.

Another exemplary embodiment of a signal conversion apparatus comprises a video input interface, an audio input interface, a conversion unit, and a plurality of output interfaces. The video input interface receives a video signal encoded in a first format from a host device. The audio input interface receives an audio signal encoded in a second format from the host device. The conversion unit is coupled to the video input interface and the audio input interface, receives the video signal and the audio signal therefrom, converts the video signal and the audio signal into a converted signal encoded in a predetermined format, and processes and splits the converted signal into a plurality of output signals each corresponding to one of the display devices. The output interfaces, each corresponds to one of the display devices, receive the corresponding output signals and transmits the corresponding output signals to the corresponding display devices.

An exemplary embodiment of a display system comprises a host device, a display device and a signal conversion apparatus. The host device provides a video signal encoded in a first format and an audio signal encoded in a second format. The signal conversion apparatus receives the video signal and the audio signal from the host device, and converts the video signal and the audio signal into an output signal encode in a predetermined format for transmission through a DisplayPort interface. The display device receives and displays the output signal.

A detailed description is given in the following embodiments with reference to the accompanying drawings.

### BRIEF DESCRIPTION OF DRAWINGS

The invention can be more fully understood by reading the subsequent detailed description and examples with references made to the accompanying drawings, wherein:

FIG. 1 shows a display system according to an embodiment of the invention;

FIG. 2 shows a signal conversion apparatus according to an embodiment of the invention;

FIG. 3 shows a DisplayPort cable connecting the signal conversion apparatus and the display device according to an embodiment of the invention; and

FIG. 4 shows a signal conversion apparatus according to another embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

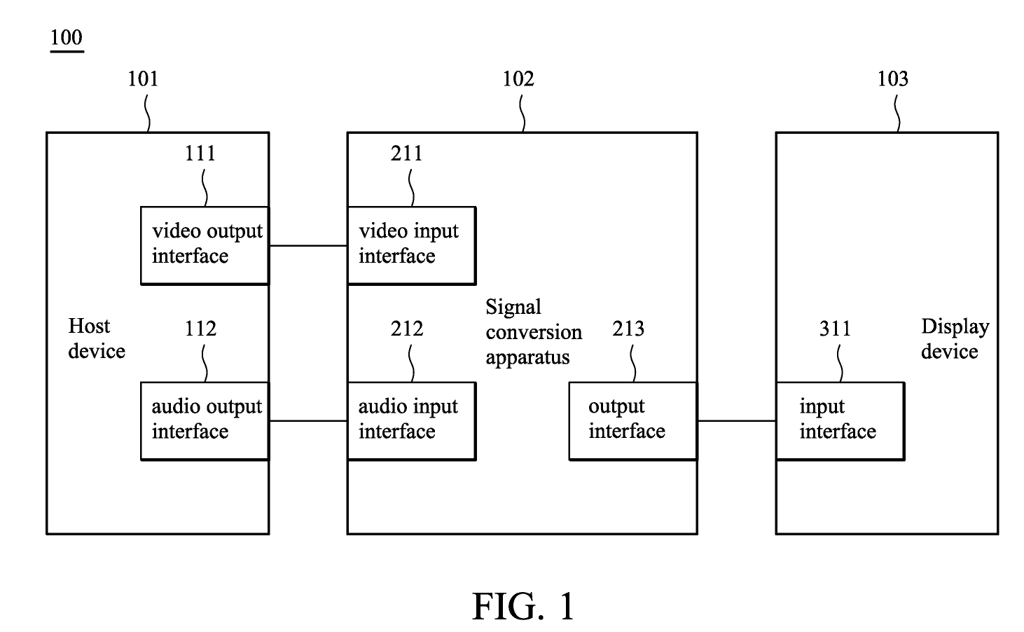

FIG. 1 shows a display system according to an embodiment of the invention. As shown in FIG. 1, the display system 100 comprises a host device 101, a signal conversion apparatus 102, and a display device 103. The host device 101 provides a video signal that is encoded in a first predetermined format and an audio signal that is encoded in a second predetermined format. According to the embodiments of the invention, the host device 101 may be a personal computer, a VCD/DVD player, a digital camera, a digital video recorder, or the like. The video signal and audio signal provided by the host device 101 may be encoded in either analog or digital format. The host device 101 comprises a video output interface 111 providing a video output port to output the video signal. According to the embodiments of the invention, the video output interface 111 may be a VGA interface, a DVI, a Dsub interface, a USB (Universal Serial Bus) interface, an IEEE 1394 interface, or an HDMI. The host device 101 also comprises an audio output interface 112 providing an audio output port to output the audio signal. According to the embodiments of the invention, the audio output interface 112 may be a USB audio interface, an S/PDIF (Sony/Philips Digital Interconnect Format) interface, a stereo interface and an Integrated Interchip Sound (I²S) interface.

The signal conversion apparatus 102 may be disposed externally to the host device 101 and adapted to detachably connect to the host device 101. The signal conversion apparatus 102 comprises a video input interface 211 and an audio input interface 212 respectively receiving the video signal and the audio signal from the host device 101. The signal conversion apparatus 102 converts the video signal and the audio signal into an output signal encoded in a predetermined output format supported by the display device 103. According to the embodiment of the invention, the predetermined output format may be transmitted through a DisplayPort interface. The display device 103 finally receives and displays the output signal. According to the embodiment of the invention, the display device 103 may be a flat panel display device, such as a LCD monitor, capable of displaying the video and audio portion of the output signal.

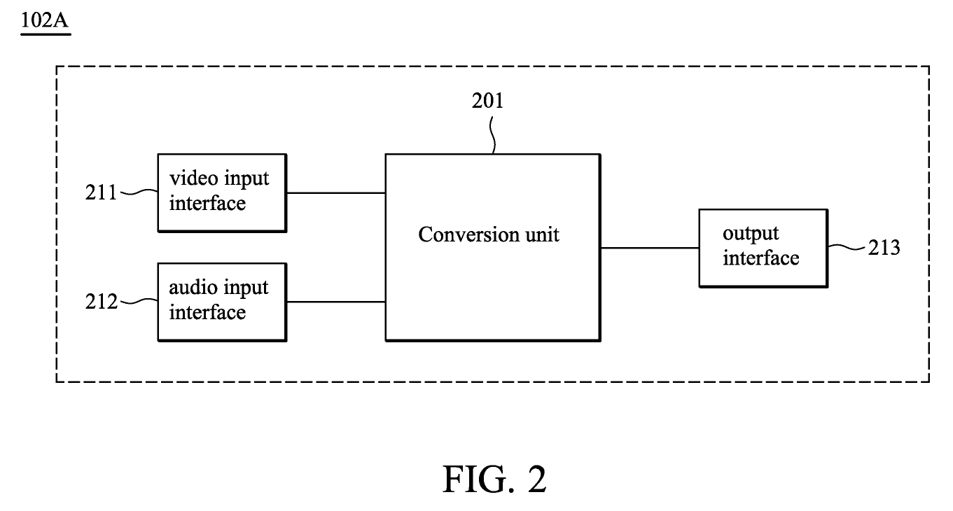

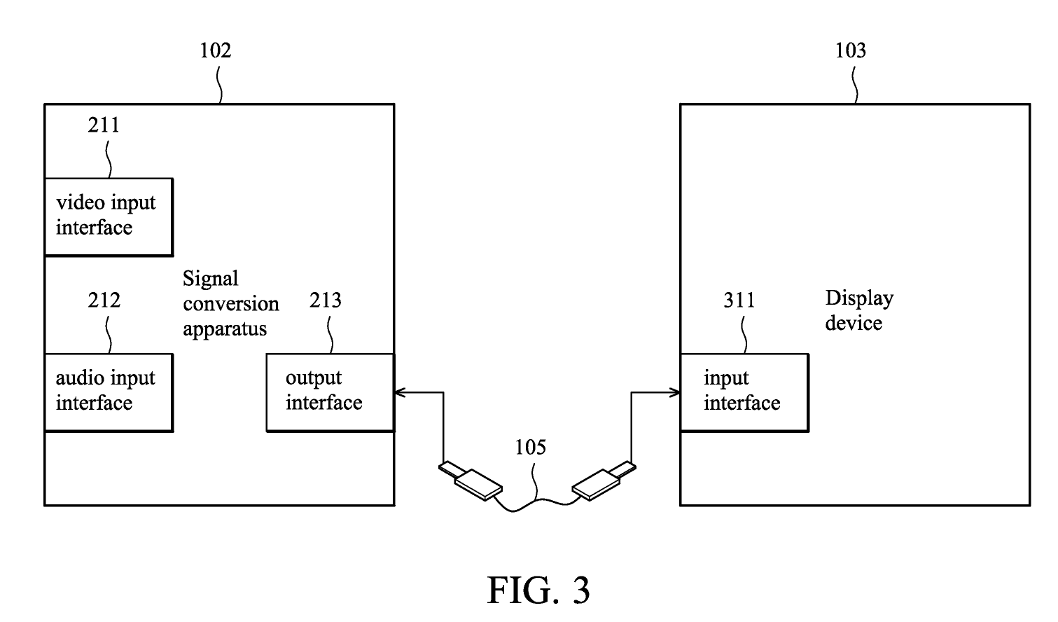

FIG. 2 shows a signal conversion apparatus according to an embodiment of the invention. As shown in FIG. 2, the signal conversion apparatus 102A comprises the video input interface 211, the audio input interface 212, a conversion unit 201 and an output interface 213. The video input interface 211 and the audio input interface 212 respectively receive the video signal and the audio signal from the host device 101. The conversion unit 201 is coupled to the video input interface 211 and the audio input interface 212, receives the video signal and the audio signal therefrom, and converts the video signal and the audio signal into the output signal encoded in a predetermined output format. The output interface 213 receives the output signal and transmits the output signal to the display device 103. According to the embodiment of the invention, the video input interface 211 may comprise a video input socket (not shown) for connecting the video output port of the host device 101, and the video input interface 211 may be a VGA interface, a DVI, a Dsub interface, a USB interface, an IEEE 1394 interface, or an HDMI, corresponding to the video output interface 111 of the host device 101. The audio input interface 212 may comprise an audio input socket (not shown) for connecting an audio output port of the host device 101, and the audio input interface 212 may be a USB audio interface, an S/PDIF interface, a stereo interface, and an I²S interface. According to the embodiment of the invention, the output interface 213 may also designed to comprise a DisplayPort socket and to connect the display device 103 via a DisplayPort cable 105 as shown in FIG. 3.

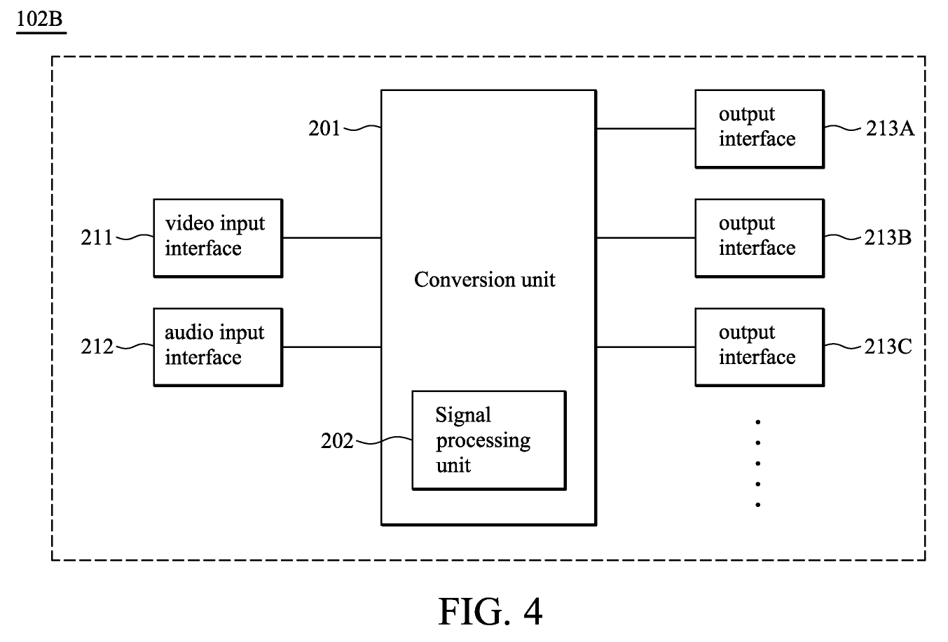

FIG. 4 shows a signal conversion apparatus according to another embodiment of the invention. As shown in FIG. 4, the signal conversion apparatus 102B comprises a video input interface 211 receiving the video signal encoded in the first predetermined format from the host device 101 as previously described, an audio input interface 212 receiving the audio signal encoded in the second predetermined format from the host device 101 as previously described, and a conversion unit 201 coupled to the video input interface 211 and the audio input interface 212, receiving the video signal and the audio signal therefrom, and converting the video signal and the audio signal into a converted signal encoded in a predetermined output format. The predetermined output format may be transmitted through a DisplayPort interface. As shown in FIG. 4, the signal conversion apparatus 102B further comprises a plurality of output interfaces 213A˜213C each corresponding to one of a plurality of display devices (not shown), and a signal processing unit 202 processing and splitting the converted signal into a plurality of output signals each corresponding to one of the display devices. Each output interface 213A˜213C receives the corresponding output signal and transmits the corresponding output signal to the corresponding display device. According to the embodiments of the invention, the signal processing unit 202 may perform a multitude of digital signal processing procedures on the converted signal so as to provide different visual or sound effects. For example, a plurality of video channels may be displayed on different primary or secondary display devices so as to achieve the monitoring operation via the primary and the secondary display devices.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. A signal conversion apparatus, comprising:
a video input interface receiving a video signal from a host device, wherein the video signal is encoded in a first format;
an audio input interface receiving an audio signals from the host device, wherein the audio signal is encoded in a second format;
a conversion unit coupled to the video input interface and the audio input interface, receiving the video signal and the audio signal therefrom, and converting the video signal and the audio signal into an output signal encoded in a predetermined format; and
a DisplayPort interface receiving the output signal and transmitting the output signal to the display device.

2. The signal conversion apparatus as claimed in claim 1, wherein the video input interface is selected from the group consisting of a VGA (Video Graphics Array) interface, a DVI (Digital Video Interface), a Dsub (Dsubminiature) interface, a USB (Universal Serial Bus) interface, an IEEE 1394 interface, and an HDMI (High Definition Multimedia Interface).

3. The signal conversion apparatus as claimed in claim 1, wherein the audio input interface is selected from the group consisting of a USB audio interface, an S/PDIF (Sony/Philips Digital Interconnect Format) interface, a stereo interface, and an Integrated Interchip Sound (I²S) interface.

4. The signal conversion apparatus as claimed in claim 1, wherein the display device is a flat panel display device.

5. The signal conversion apparatus as claimed in claim 1, wherein the host device is selected from the group consisting of a personal computer, a VCD/DVD player, a digital camera, and a digital video recorder.

6. A signal conversion apparatus, comprising:
a video input interface receiving a video signal from a host device, wherein the video signal is encoded in a first format;
an audio input interface receiving an audio signal from the host device, wherein the audio signal is encoded in a second format;
a conversion unit coupled to the video input interface and the audio input interface, receiving the video signal and the audio signal therefrom, converting the video signal and the audio signal into a converted signal encoded in a predetermined format, and processing and splitting the converted signal into a plurality of output signals each corresponding to one of display devices; and
a plurality of DisplayPort interfaces each corresponding to one of the display devices, receiving the corresponding output signals and transmitting the corresponding output signals to the corresponding display devices.

7. The signal conversion apparatus as claimed in claim 6, wherein the video input interface is selected from the group consisting of a VGA (Video Graphics Array) interface, a DVI (Digital Video Interface), a Dsub (Dsubminiature) interface, a USB (Universal Serial Bus) interface, an IEEE 1394 interface, and an HDMI (High Definition Multimedia Interface).

8. The signal conversion apparatus as claimed in claim 6, wherein the audio input interface is selected from the group consisting of a USB audio interface, an S/PDIF (Sony/Philips Digital Interconnect Format) interface, a stereo interface, and an Integrated Interchip Sound (I²S) interface.

9. The signal conversion apparatus as claimed in claim 6, wherein the conversion unit further comprises a signal processing unit processing and splitting the converted signal into the output signals each corresponding to one of the display devices.

10. A display system, comprising:
a host device providing a video signal encoded in a first format and an audio signal encoded in a second format;
a signal conversion apparatus receiving the video signal and the audio signal from the host device, and converting the video signal and the audio signal into an output signal encode in a predetermined format for transmission through a DisplayPort interface; and
a display device receiving and displaying the output signal.

11. The display system as claimed in claim 10, wherein the signal conversion apparatus further comprises:
a video input interface receiving the video signal from the host device;
an audio input interface receiving the audio signal from the host device;
a conversion unit coupled to the video input interface and the audio input interface, receiving the video signal and the audio signal therefrom, and converting the video signals and the audio signals into the output signal; and
a DisplayPort interface receiving the output signal and transmitting the output signal to the display device.

12. The display system as claimed in claim 10, wherein the signal conversion apparatus further connects the display device via a DisplayPort cable.

13. The display system as claimed in claim 10, wherein the signal conversion apparatus is disposed externally to the host device and adapted to detachably connect to the host device.

14. The display system as claimed in claim 11, wherein the video input interface comprises a video input socket for connecting a video output port of the host device and is selected from the group consisting of a VGA (Video Graphics Array) interface, a DVI (Digital Video Interface), a Dsub (Dsubminiature) interface, a USB (Universal Serial Bus) interface, an IEEE 1394 interface, and an HDMI (High Definition Multimedia Interface).

15. The display system as claimed in claim 11, wherein the audio input interface comprises an audio input socket for connecting an audio output port of the host device and is selected from the group consisting of a USB audio interface, an S/PDIF (Sony/Philips Digital Interconnect Format) interface, a stereo interface, and an Integrated Interchip Sound (I²S) interface.
